(19) United States
(12) Patent Application Publication
(10) Pub. No.: US 2014/0140598 A1
(43) Pub. Date: May 22, 2014

(54) SYSTEMS AND METHODS FOR 2D AND 3D IMAGE INTEGRATION AND SYNCHRONIZATION

(71) Applicant: GENERAL ELECTRIC COMPANY, Schenectady, NY (US)

(72) Inventors: Yao Lu, Park Ridge, NJ (US); Jean Labarre, Barrington, IL (US); Antoine Aliotti, Buc Cedex (FR); Christopher John Olivier, Park Ridge, NJ (US); Dan Liu, Norwalk, CT (US); Bence Lantos, Budaors (HU)

(73) Assignee: General Electric Company, Schenectady, NY (US)

(21) Appl. No.: 13/683,651

(22) Filed: Nov. 21, 2012

(51) Int. Cl. G06T 7/00

(52) U.S. Cl. CPC G06T 7/0012
USPC 382/131

(57) ABSTRACT

System and methods for 2D and 3D image integration and synchronization are disclosed. An example method includes displaying a first two-dimensional image via a first image viewer on a first screen, wherein the first two-dimensional image is from a first set of images and displaying a three-dimensional image via a second image viewer on the first screen, wherein the three-dimensional image is constructed from the first set of images and wherein the first image viewer and the second image viewer are linked to share commands and messages. The example method also includes receiving a first instruction to modify a selected one of the first two-dimensional image or the three-dimensional image, modifying the selected one of the first two-dimensional image or the three-dimensional image based on the first instruction via the first image viewer or the second image viewer corresponding to the selected image and correspondingly modifying the other of the first two-dimensional image or the three-dimensional image based on the first instruction via the other of the first image viewer or the second image viewer corresponding to the unselected one of the first two-dimensional image or the three-dimensional image.

### FIELD OF THE DISCLOSURE

The present disclosure relates generally to medical imaging and, more particularly, to systems and methods for two-dimensional and three-dimensional image integration and synchronization.

### BACKGROUND

Medical imaging devices typically record a series of two-dimensional images of a patient. This series of 2-dimensional images can be used to create a 3-dimensional image using tomography or other mathematical techniques.

### BRIEF SUMMARY

Example systems and methods provide for 2D and 3D image integration and synchronization.

An example method includes displaying a two-dimensional image via a first image viewer on a screen, wherein the two-dimensional image is from a set of images. The example method includes displaying a three-dimensional image via a second image viewer on the screen, wherein the three-dimensional image is constructed from the set of images and wherein the first image viewer and the second image viewer are linked to share commands and messages. The example method includes receiving an instruction to modify either the two-dimensional image or the three-dimensional image. The example method includes modifying either the selected two-dimensional image or three-dimensional image based on the instruction via the first image viewer or the second image viewer corresponding to the selected image. The example method includes correspondingly modifying the two-dimensional image or the three-dimensional image that was not selected based on the instruction via the first image viewer or the second image viewer corresponding to the two-dimensional image or the three-dimensional image that was not selected.

An example tangible computer readable medium has a set of instructions that when read, cause the computer to at least display a two-dimensional image via a first image viewer on a screen, wherein the two-dimensional image is from a set of images. The example instructions cause the computer to display a three-dimensional image via a second image viewer on the screen, wherein the three-dimensional image is constructed from the set of images and wherein the first image viewer and the second image viewer are linked to share commands and messages. The example instructions cause the computer to receive an instruction to modify either the two-dimensional image or the three-dimensional image. The example instructions cause the computer to modify the selected two-dimensional image or three-dimensional image based on the instruction via the first image viewer or the second image viewer corresponding to the selected image. The example instructions cause the computer to correspondingly modify the two-dimensional image or the three-dimensional image that was not selected based on the instruction via the first image viewer or the second image viewer corresponding to the two-dimensional image or three-dimensional image that was not selected.

An example apparatus includes a first image viewer to display a two-dimensional image on a screen, wherein the two-dimensional image is from a set of images. The example apparatus includes a second image viewer to display a three-dimensional image on the screen, wherein the three-dimensional image is constructed from the set of images and wherein the first image viewer and the second image viewer are linked to share commands and messages. The example apparatus includes an input terminal to receive an instruction to modify either the two-dimensional image or the three-dimensional image, wherein upon receiving the instruction, either the first image viewer or the second image viewer corresponding to the selected image modifies either the selected two-dimensional image or the three-dimensional image based on the instruction and the first image viewer or the second image viewer corresponding to the two-dimensional image or the three-dimensional image that was not selected correspondingly modifies the two-dimensional image or the three-dimensional image that was not selected based on the instruction.

### BRIEF DESCRIPTION OF THE DRAWINGS

FIG. 1 is a block diagram of an example medical imaging system constructed in accordance with the teachings of this disclosure.

FIG. 2 is an illustration of the example monitor of the medical imaging system of FIG. 1.

FIGS. 3-5 are flowcharts representative of example machine readable instructions that may be executed to implement the example medical imaging system of FIG. 1.

FIG. 6 is an example screenshot of an example output of the medical imaging system of FIG. 1.

FIG. 7 is a block diagram of an example processing system capable of executing the example machine readable instructions of FIGS. 3-5 to implement the example medical imaging system of FIG. 1.

### DETAILED DESCRIPTION

Medical images of the human body are often used by doctors and other medical professionals to help diagnose and treat patients. Various medical imaging technologies can be used for this purpose, such as magnetic resonance imaging (MRI), positron emission tomography (PET), x-ray computed tomography (CT), or ultrasound. Typically, a medical imaging device using one of these imaging technologies or any other imaging technology scans a portion of a patient's body and creates a series of two-dimensional (2D) images or slices representing a series of cross-sections of the scanned portion of the patient's body. This series of 2D images can then be viewed by a doctor or others.

Alternatively, this series of 2D images can be used to construct a three-dimensional (3D) volume image of the scanned portion of the patient's body. This 3D image construction is typically done by computer software using a mathematical technique such as tomography. Because the 3D volume image is constructed from the series of 2D images, it is typically only possible to view either one of the 2D image or the constructed 3D image at any given time. A doctor would typically use one software program to view the 2D images and another completely different software program to view the 3D volume image. In some instances, these two different software programs might reside on different workstations, meaning that doctor would need to look at one workstation to view the 2D images and a different workstation to view the 3D volume image.

Furthermore, medical imaging software typically has a number of tools for enhancing, clarifying, rotating, changing the zoom level or otherwise modifying a displayed image. These various tools allow a displayed image to be fine-tuned to assist a doctor in making a diagnosis or any other purpose for which the image is being viewed. Because the 2D images and the 3D image can only be viewed with different software programs or even on different workstations, any image modification tools used on any of the 2D images will have no effect on the 3D image and vice versa.

Example systems, methods, apparatus, and/or articles of manufacture disclosed herein provide a mechanism for viewing one image from a series of 2D images alongside a 3D volume image constructed from the series of 2D images. In particular, examples disclosed herein provide a mechanism for viewing the 2D image and the 3D image on the same screen and in synchronicity with each other. Examples disclosed herein provide tools to modify the viewing conditions for the displayed 2D image that make a corresponding modification to the viewing conditions of the displayed 3D image. Examples disclosed herein provide tools to modify the viewing conditions for the displayed 3D image that make a corresponding modification to the viewing conditions of the displayed 2D image. Examples disclosed herein provide tools to load a different image from the series of 2D images that cause the view of the displayed 3D image to change to show the position in the 3D image corresponding to the loaded 2D image. Examples disclosed herein provide tools to change the cursor position in the displayed 3D image that cause a new 2D image to be loaded corresponding to the new cursor position in the 3D image. Specifically, two different software applications run simultaneously on a computer system. One software application displays a 2D image and the other software application displays a 3D image. The two software applications operate independently but communicate with each other by sending extensible markup language (XML) commands to each other. At any given time, a user controls one of the two software applications to modify the image displayed by that application. The application being controlled by the user then sends XML commands to the other software application with information about how the image displayed by the other software application should be modified.

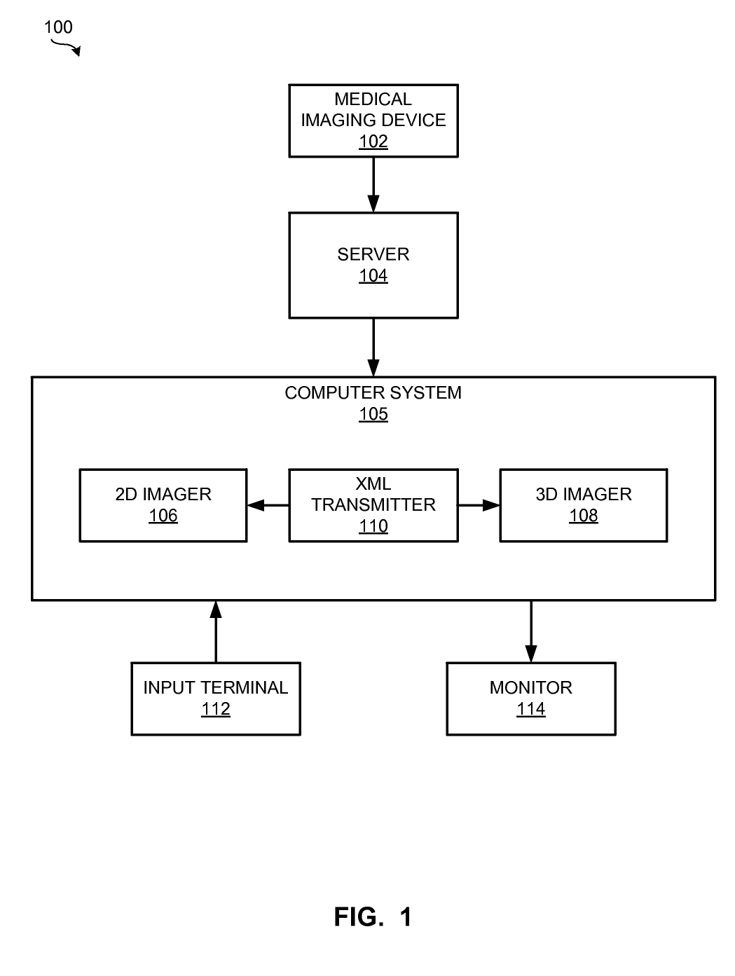

FIG. 1 is a block diagram of an example medical imaging system 100 constructed in accordance with the teachings of this disclosure. The example imaging system 100 of FIG. 1 includes a medical imaging device 102. This medical imaging device 102 can be any device capable of recording medical images such as an MRI, PET, CT or ultrasound scanner or any other such device. The example medical imaging device 102 scans a portion of a patient's body and stores the results of the scan on a server 104. The example server 104 communicates with the medical imaging device 102 in order to receive medical imaging data from the medical imaging device 102. The server 104 also has a database or other storage capability to store medical imaging data received from the medical imaging device 102.

As the medical imaging device 102 scans a portion of the patient's body, a series of 2D images are created. Each of these 2D images represents a cross-section of the scanned portion of the patient's body. In some examples, the results of the scan are stored on the example server 104 in a Digital Imaging and Communications in Medicine (DICOM) format. The scan results are then transmitted from the medical imaging device 102 to the server 104 and stored on the server 104.

The example imaging system includes a computer system 105. The example computer system 105 communicates with the example server 104 to load 2D images stored on the server 104 from the server 104 to the computer system 105. The computer system 105 is connected to the server 104 either directly or via a network. If a network connection is used, the network may be implemented using any type of public or private network such as, but not limited to, the Internet, a telephone network, a local area network (LAN), a cable network, and/or a wireless network. To enable communication via the network, the computer system 105 may include a communication interface that enables connection to an Ethernet, a digital subscriber line (DSL), a telephone line, a coaxial cable, or any wireless connection, etc.

The example computer system 105 communicates with an input terminal 112 to receive input from a user. The example computer system 105 communicates with a monitor 114 to display images and other output to a user. The example computer system also includes a 2D imager 106, a 3D imager 108 and an XML transmitter 110.

The example 2D imager 106 is a software application that runs on the example computer system 105. In one example, the 2D imager 106 is written in C++, however any other programming language can be used to implement the 2D imager 106. The 2D imager 106 controls an image viewer to display one or more 2D images. After the computer system 105 receives the 2D images from the server 104, the 2D images are sent to the 2D imager 106 wherein the series of 2D images comprise one scan taken by the medical imaging device 102. The 2D imager 106 stores the series of 2D images until another series of 2D images comprising another scan by the medical imaging device 102 is loaded from the server 104 to the computer system 105.

The 2D imager 106 communicates, through device drivers on the computer system 105, with the input terminal 112 and the monitor 114. The 2D imager sends one or more 2D images to the monitor 114 to be displayed on the monitor 114. The 2D imager receives input from a user through the input terminal 112. The 2D imager 106 sends XML commands to a 3D imager 108 via the XML transmitter 110. The 2D imager 106 also receives XML commands from the example 3D imager 108 via the example XML transmitter 110. In one example, the XML transmitter 110 includes two TCP/IP ports, wherein one port is used to send XML commands from the 2D imager 106 to the 3D imager 108 and the other port is used to send XML commands from the 3D imager 108 to the 2D imager 106. While the transmitter 110 is labeled as an XML transmitter for purposes of illustration, and resulting commands are identified as XML commands, it is understood that commands could be generated according to other formats. The example XML transmitter 110 therefore facilitates the transmission of XML commands between the example 2D imager 106 and the example 3D imager 108. The communication protocol between the 2D imager 106 and the 3D imager 108 is established through known handshaking techniques.

The example 3D imager 108 is a software application that runs on the example computer system 105. In one example, the 3D imager 108 is written in JAVA, however any other programming language can be used to implement the 3D imager 108. The 3D imager 108 controls an image viewer to display one or more views of a 3D image from different viewing angles. After the computer system 105 receives the 2D images from the server 104, the 2D images are sent to the 3D imager 108, wherein the series of 2D images is the same series of 2D images sent to the 2D imager 106. After the series of 2D images is received by the 3D imager 108, the 3D imager 108 constructs a 3D volume image of the portion of the patient's body that was scanned from the series of 2D images. The 3D imager 108 constructs the 3D volume image using tomography or some other technique of three-dimensional image construction from a series of two-dimensional cross-sectional images. The 3D imager 108 stores the constructed 3D image until another series of 2D images comprising another scan by the medical imaging device 102 is loaded from the server 104 and a new 3D image is constructed.

The 3D imager 108 communicates, through device drivers on the computer system 105, with the input terminal 112 and the monitor 114. The 3D imager sends one or more views of a 3D image to the monitor 114 be displayed on the monitor 114. The 3D imager receives input from a user through the input terminal 112. The 3D imager 108 receives XML commands from the 2D imager 106 via the XML transmitter 110. The 3D imager 108 also sends XML commands to the 2D imager 106 via the XML transmitter 110.

The example monitor 114 communicates with the 2D imager 106 and the 3D imager 108. The monitor 114 displays the output from the 2D imager 106 and the output from the 3D imager 108. Although, the 2D imager 106 and the 3D imager 108 are two separate applications executing on the computer system 105, their outputs on the monitor 114 are displayed in such a way that they appear to the user to be a single application.

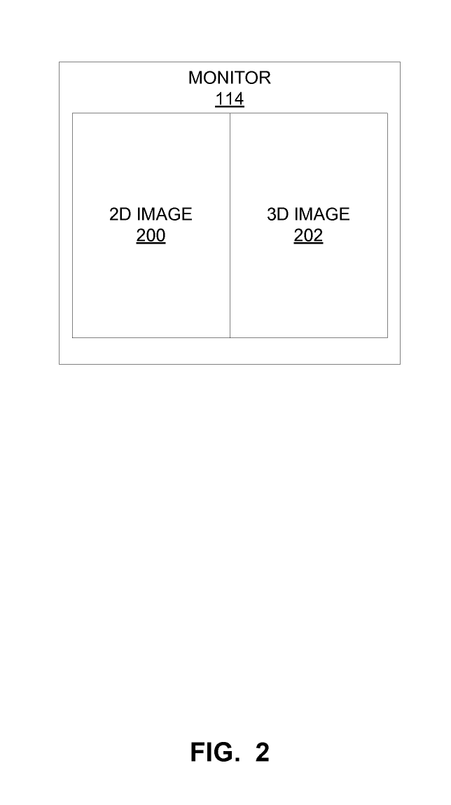

The 2D imager 106 sends one or more 2D image to the monitor 114, wherein the one or more 2D images are from the series of 2D images stored on the 2D imager 106. The 3D imager 108 sends one or more views of the constructed 3D volume image to the monitor 114. The monitor 114 displays the one or more received 2D images and the one or more received views of the 3D image. FIG. 2 illustrates an example display of the monitor 114 and its display. In the example of FIG. 2 only one 2D image and one 3D image are displayed. In other examples, multiple 2D images and multiple views of the 3D image could be displayed. In the example of FIG. 2, one portion of the monitor 114 displays a 2D image 200 received from the 2D imager 106. Another portion of the monitor 114 displays a 3D image 202 received from the 3D imager 108. However, the sizes of the 2D image 200 and the 3D image 202 can vary, the positions of the 2D image 200 and the 3D image can vary and one of the images can partially overlap the other. As the 2D image 200 sent by the 2D imager 106 and the 3D image 202 sent by the 3D imager 108 are changed, as explained in further detail below, the 2D image 200 and the 3D image 202 displayed on the monitor 114 are updated accordingly.

The input terminal 112 of FIG. 1 is the mechanism by which a user interacts with the imaging system 100. The input terminal 112 communicates with the 2D imager 106 and the 3D imager 108. The input terminal 112 includes a mouse and a keyboard. The input terminal 112 can also include other methods of providing input to the imaging system 100. The input terminal 112 is used to modify what is displayed on the monitor 114.

One way that the display on the monitor 114 can be changed is that the user can use the input terminal 112 to resize and/or move the 2D image 200 and/or the 3D image 202. In FIG. 2, 2D image 200 and 3D image 202 are the same size and take up the same amount of space on the monitor 114. However, both the 2D image 200 and the 3D image 202 can be resized and/or moved through the use of the input terminal 112. The view on the monitor 114 can be modified such that the size of the 2D image 200 and/or the size of the 3D image 202 can be increased or decreased. Also, the 2D image 200 and/or the 3D image 202 can be minimized completely so that only one image is displayed on the monitor 114. Also, the position of either of the 2D image 200 and the 3D image 300 can be moved.

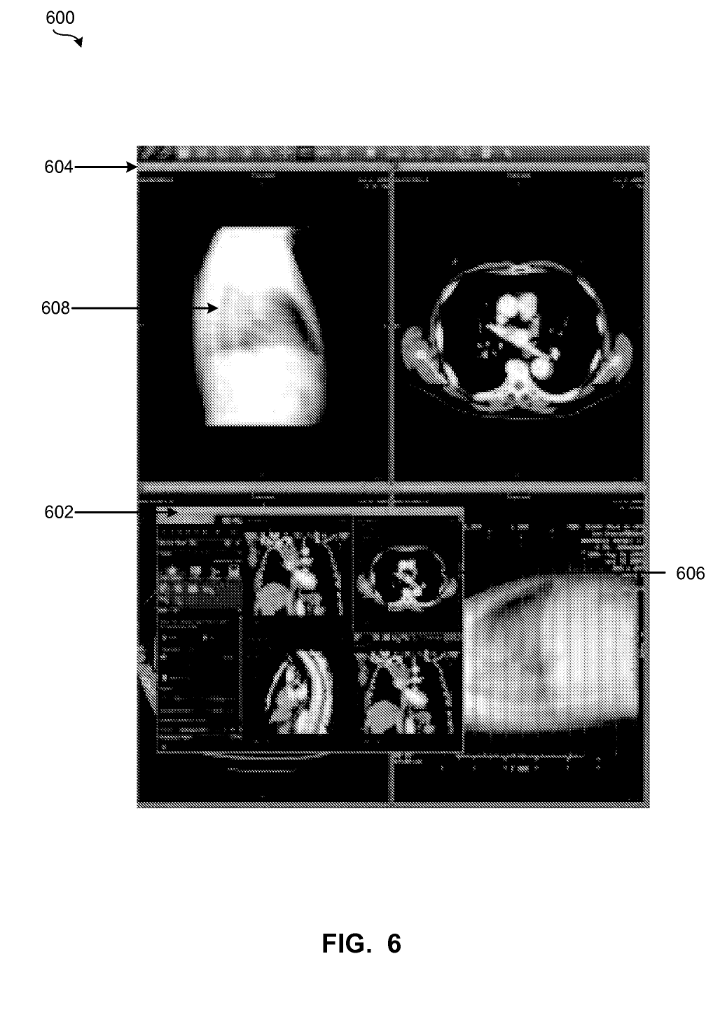

FIG. 6 illustrates a screenshot 600 of an example display of the monitor 114 of the example imaging system 100. Window 602 illustrates an example output of the 2D imager 106 and window 604 illustrates an example output of the 3D imager 108. In the example of FIG. 6, the 2D imager 106 has sent four 2D images to the monitor 114 and the 3D imager 108 has sent four views of the 3D image to the monitor 114. Window 602, the output of the 2D imager 106 has been made smaller than window 604, the output of the 3D imager 108. In the example of FIG. 6, window 602 displays four different 2D images and window 604 displays four different angles of the constructed 3D image, although only two of those views are completely visible in FIG. 6 as the other two views are partially obscured by window 600. Image 606 of FIG. 6 illustrates one of the four images output by the 2D imager 106. Image 608 of FIG. 6 illustrates one of the four images output by the 3D imager 108.

In addition to resizing the 2D image 200 and the 3D image 202, the input terminal 112 can be used to modify what is displayed as the 2D image 200 and the 3D image 202. Certain mouse and keyboard commands can cause the input terminal 112 to send commands to the 2D imager 106 or the 3D imager 108. When commands are received from the input terminal 112 by the 2D imager 106, the 2D imager 106 modifies the 2D image 200 accordingly and sends the modified 2D image 200 to the monitor 114, which then updates the 2D image 200 displayed on the monitor 114. When commands are received from the input terminal 112 by the 3D imager 108, the 3D imager 108 modifies the 3D image 202 accordingly and sends the modified 3D image 202 to the monitor 114, which then updates the 3D image 202 displayed on the monitor 114. Any known image processing or image modification technique can be applied by either the 2D imager 106 or the 3D imager 108 such as modifying the zoom level of an image, modifying the contrast of an image, or modifying the window/level of an image. There are also many image modification tools typically used in radiology that can be applied by either the 2D imager 106 or the 3D imager 108 as well. Any such image modification can be programmed to be triggered by any type of input made by a user into the example input terminal 112 such as any series of keyboard or mouse commands.

Any such input made to the input terminal 112 to modify the display of the 2D image 200 causes the input terminal 112 to send a command to the 2D imager 106 to cause the 2D imager 106 to make the appropriate requested modification to the 2D image 200 that is sent to and displayed on the monitor 114. In addition, when any such modifications are made to the 2D image 200, the 2D imager 106 also sends XML commands to the 3D imager 108 via the example XML transmitter 110. The XML commands sent from the 2D imager 106 to the 3D imager 108 via the XML transmitter 110 instruct the 3D imager 108 to make the same changes to the 3D image 202 that that 2D imager 106 made to the 2D image 200. For example, if the input terminal 112 instructs the 2D imager 106 to change the window/level contrast of the 2D image 200, the 2D imager 106 sends XML commands to the 3D imager 108 instructing the 3D imager 108 to make the same adjustments to the window/level contrast of the 3D image 202. This ensures that the view of the 2D image 200 and the view of the 3D image 202 stay in synch with each other.

Similarly, any input by the user to the input terminal 112 to modify the display of the 3D image 202 causes the input terminal 112 to send a command to the 3D imager 108 to cause the 3D imager 108 to make the appropriate requested modification to the 3D image 202 that is sent to and displayed on the monitor 114. In addition, when any such modifications are made to the 3D image 202, the 3D imager 108 also sends XML commands to the 2D imager 106 via the example XML transmitter 110. The XML commands sent from the 3D imager 108 to the 2D imager 106 via the XML transmitter 110 instruct the 2D imager 106 to make the same changes to the 2D image 200 that that 3D imager 108 made to the 3D image 202. For example, if the input terminal 112 instructs the 3D imager 108 to change the zoom level of the 3D image 202, the 3D imager 108 sends XML commands to the 2D imager 106 instructing the 2D imager 106 to make the same adjustments to the zoom level of the 2D image 200.

The example input terminal 112 can also cause the 2D imager 106 to send a new 2D image 200 to the monitor 114, wherein the new 2D image 200 is another one of the series of 2D images stored on the 2D imager 106. Since the series of 2D images stored on the 2D imager 106 represent different cross sections of the portion of the patient's body scanned by the medical imaging device 102, loading a new 2D image 200 allows a different cross section to be viewed on the monitor 114. Accordingly, when a command to load a new 2D image 200 is made to the input terminal 112, the input terminal 112 sends a command to the 2D imager 106 causing the 2D imager 106 to load a new 2D image 200 and send the new 2D image 200 to the monitor 114 where it is displayed.

When a new 2D image 200 is loaded by the 2D imager 106, the 3D image 202 must be modified to maintain synchronicity with the displayed 2D image 200. This is accomplished by moving a pointer on the 3D image 202. The pointer can be any conspicuous dot or symbol that highlights a specific point on the 3D image 202. The 3D volume image 202 is constructed from the series of two-dimensional cross sections recorded by the medical imaging device 102. Accordingly, any given cross section of the 3D image 202 corresponds to one of the 2D images stored on the 2D imager 106. Likewise, each one of the 2D images stored on the 2D imager 106 corresponds to a cross section of the 3D volume image 202. Therefore, in order to synchronize the view of the 2D image 200 and the 3D image 202, whenever a new 2D image 200 is loaded by the 2D imager 106, the 2D imager 106 sends XML commands to the 3D imager 108 instructing the 3D imager 108 to move the pointer to a location on the 3D image 202 in which the cross section of the 3D image 202 at that location corresponds to the 2D image 200 that was loaded. When the XML commands are received by the 3D imager 108, the 3D imager 108 changes the 3D image 202 such that the pointer is moved to the appropriate location and then sends the updated 3D image 202 to the monitor 114 for display.

The input terminal 112 can also be used to move the pointer to any location on the 3D image 202. When this is done, the 2D image 200 must change in order to keep the 2D image 200 and the 3D image 202 in synchronization. Accordingly, when the user makes an input to the input terminal 112 to move the 3D pointer, the input terminal 112 instructs the 3D imager 108 to move the pointer to the appropriate location. The 3D imager 108 then changes the 3D image 202 such that the pointer is in the new location and sends the 3D image 202 to the monitor 114 to be displayed. The 3D imager 108 also sends XML commands to the 2D imager 106 instructing the 2D imager 106 to load a new 2D image 200. The new 2D image 200 to be loaded is the cross section of the 3D image 202 that is closest to the point on the 3D image 202 where the pointer is. When the 2D imager 106 receives the XML commands, the 2D imager 106 loads the appropriate 2D image 200 and sends the 2D image 200 to the monitor 114 for display.

The input terminal 112 can also be used to add labels and/or annotations to the 2D image 200. When the input terminal 112 sends a command to the 2D imager 106 to add a label or annotation to the 2D image 200, the 2D imager 106 adds the requested label or annotation to the 2D image 200 and sends the updated 2D image 200 to the monitor 114 for display. The 2D imager 106 also sends XML commands to the 3D imager 108 instructing the 3D imager 108 to add the same label or annotation to the 3D image 202. The XML commands sent by the 2D imager 106 instruct the 3D imager 108 to add the label or annotation to the 3D image 202 at a point on the 3D image 202 with the cross section represented by the 2D image 200 so that the two images are synchronized. The 3D imager 108 receives the XML commands, adds the label or annotation in the appropriate location to the 3D image 202 and sends the 3D image 202 to the monitor 114 for display.

The input terminal 112 can also be used to add labels and/or annotations to the 3D image 202. When the input terminal 112 sends a command to the 3D imager 108 to add a label or annotation to the 3D image 202, the 3D imager 108 adds the requested label or annotation to the 3D image 202 and sends the updated 3D image 202 to the monitor 114 for display. After adding a label or annotation to the 3D image 202, the 3D imager 108 sends XML commands to the example 2D imager 106. The XML commands sent by the 3D imager 108 to the 2D imager 106 instruct the 2D imager 106 to add the label or annotation in the correct location. However, because the 3D image 202 is a composite of all of the 2D images stored on the 2D imager 106, not all of those 2D images should have every label or annotation made to the 3D image 202. Accordingly, when a label or annotation is added to the 3D image 202, the 3D imager 108 sends XML commands to the 2D imager 106 instructing the 2D imager 106 to add the label or annotation only to the 2D images stored in the 2D imager 106 that are cross sections of the 3D image 202 that intersect the label or annotation on the 3D image 202. Upon receiving the XML commands, the 2D imager 106 internally records the label or annotation on each of the appropriate stored 2D images. As various 2D images 200 are displayed on the monitor 114, every time a 2D image 200 that has had a label or annotation added is displayed, the label or annotation is displayed on both the 2D image 200 and the 3D image 202.

While an example manner of implementing the medical imaging system 100 has been illustrated in FIG. 1, one or more of the elements, processes and/or devices illustrated in FIG. 1 may be combined, divided, re-arranged, omitted, eliminated and/or implemented in any other way. Further, the example server 104, the example 2D imager 106, the example 3D imager 108, the example XML transmitter 110, and/or, more generally, the example medical imaging system 100 of FIG. 1 may be implemented by hardware, software, firmware and/or any combination of hardware, software and/or firmware. Thus, for example, any of the example server 104, the example 2D imager 106, the example 3D imager 108, the example XML transmitter 110, and/or, more generally, the example medical imaging system 100 of FIG. 1 could be implemented by one or more circuit(s), programmable processor(s), application specific integrated circuit(s) (ASIC(s)), programmable logic device(s) (PLD(s)), microprocessor(s), hardware processor(s), and/or field programmable logic device(s) (FPLD(s)), etc. When any of the system or apparatus claims of this patent are read to cover a purely software and/or firmware implementation, at least one of the example server 104, the example 2D imager 106, the example 3D imager 108, the example XML transmitter 110, and/or, more generally, the example medical imaging system 100 of FIG. 1 is hereby expressly defined to include a tangible computer readable storage medium such as a memory, DVD, CD, Blu-ray, etc. storing the software and/or firmware. Further still, the example medical imaging system 100 of FIG. 1 may include one or more elements, processes and/or devices in addition to, or instead of, those illustrated in FIG. 1, and/or may include more than one of any or all of the illustrated elements, processes and devices.

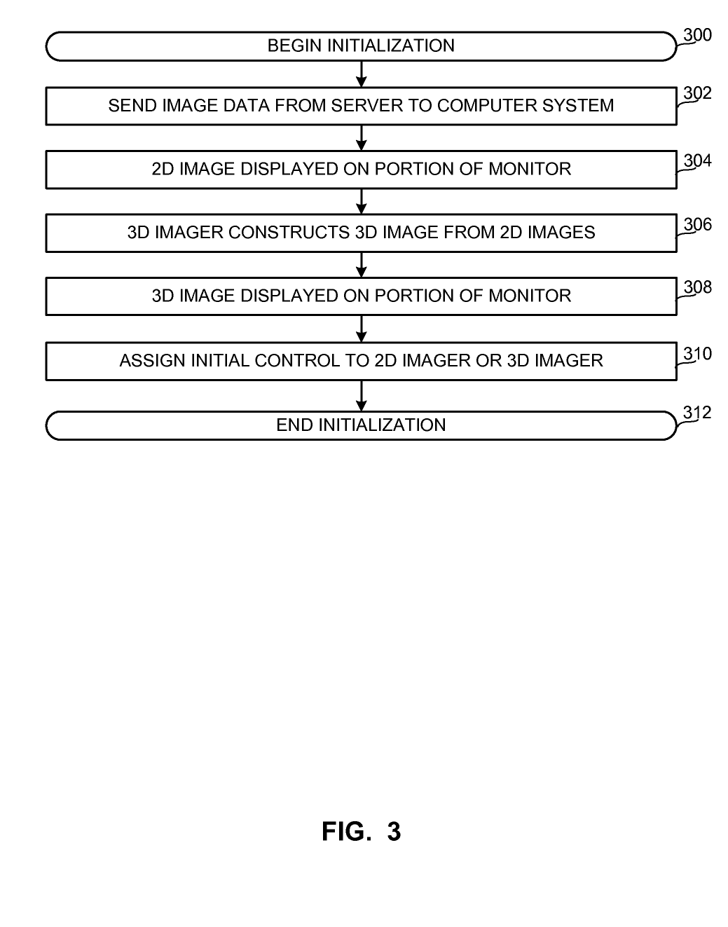

FIGS. 3-5 are flowcharts representative of example machine readable instructions for implementing the example medical imaging system 100 of FIG. 1. In the example flowcharts of FIGS. 3-5, the machine readable instructions comprise program(s) for execution by a processor such as the processor 612 shown in the example computer 600 discussed below in connection with FIG. 6. The program(s) may be embodied in software stored on a tangible computer readable storage medium such as a CD-ROM, a floppy disk, a hard drive, a digital versatile disk (DVD), a Blu-ray disk, or a memory associated with the processor 612, but the entire program and/or parts thereof could alternatively be executed by a device other than the processor 612 and/or embodied in firmware or dedicated hardware. Further, although the example program(s) is described with reference to the flowcharts illustrated in FIGS. 3-5, many other methods of implementing the example loop vectorizer 300 of FIG. 3 may alternatively be used. For example, the order of execution of the blocks may be changed, and/or some of the blocks described may be changed, eliminated, or combined.

As mentioned above, the example processes of FIGS. 3-5 may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable storage medium is expressly defined to include any type of computer readable storage device and/or disk and to exclude propagating signals. Additionally or alternatively, the example processes of FIG. 3 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable storage medium is expressly defined to include any type of computer readable storage device and/or disk and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 3 is a flowchart of example machine readable instructions to initialize the example medical imaging system of FIG. 1. Initialization begins when a user wishes to view medical images that have been recorded by the medical imaging device 102 and stored on the server 104 (block 300). The series of two-dimensional images stored on the server 104 are transferred to the computer system 105 and to the 2D imager 106 and the 3D imager 108 (block 302). The 2D imager 106 then sends one or more 2D images to the monitor 114 to be displayed on a portion of the monitor 114 (block 304). In the example of FIG. 6, four 2D images are sent to the monitor 114 and the four 2D images are displayed in window 602. One of the displayed 2D images is image 606. The 3D imager 108 constructs a three-dimensional volume image from the series of 2D images received from the server 104 using tomography or some other three-dimensional image construction technique (block 306). One or more views of the constructed 3D image is then sent to the monitor 114 to be displayed on a portion of the monitor 114 (block 308). In the example of FIG. 6, four views of the constructed 3D image, comprising four different viewing angles of the 3D image are sent to the monitor 114 and the four 3D images are displayed in window 604. One of the displayed 3D images is image 608. The imaging system 100 then assigns control to either the 2D imager 106 or the 3D imager 108 (block 310). This ends initialization of the imaging system 100 (block 312).

In certain examples, either the 2D imager 106 or the 3D imager 108 has control of the imaging system 100 at any given time. For example, the 2D imager 106 and the 3D imager 108 are separate applications executing simultaneously on the computer system 105. When the 2D imager 106 is assigned control, the user interacts with the 2D imager 106 application. Furthermore, when the 2D imager 106 has control and more than one 2D image is displayed on the monitor 114, as in window 602 of FIG. 6, the user interacts specifically with one of the 2D images displayed, such as image 606 of FIG. 6. When the 3D imager 108 is assigned control, the user interacts with the 3D imager 108 application. Furthermore, when the 3D imager has control and more than one 3D image is displayed on the monitor 114, as in window 602 of FIG. 6, the user interacts specifically with one of the 3D images displayed, such as image 608 of FIG. 6. However, this assignment of control to either the 2D imager 106 or the 3D imager 108 is mostly transparent to the user of the imaging system 100 because the outputs of the 2D imager 106 and the 3D imager 108 are displayed together on the monitor 114, as shown in the example of FIG. 6, wherein window 602 and window 604 are displayed together. In other examples, the 2D imager 106 and the 3D imager 108 are elements of a single computer software program and/or unified user interface, and the user is unaware of the existence of both a 2D imager 106 component and a 3D imager 108 component.

Whichever one of the 2D imager 106 and the 3D imager 108 has control of the imaging system 100 is the application that can accept input from the example input terminal 112 at any given time. However, the user can easily change control from the 2D imager 106 to the 3D imager 108 and vice versa. In some examples, this control can be changed by simply using a mouse that is part of the input terminal 112 and moving the mouse cursor from one side of the monitor 114 to the other. For example, in FIG. 6, the user could assign control to the 2D imager 106 by clicking anywhere in window 602 and the user could assign control to the 3D imager 108 by clicking anywhere win window 604. In some examples, after initialization, initial control is assigned to the 2D imager 106. In other examples, after initialization, initial control is assigned to the 3D imager 108.

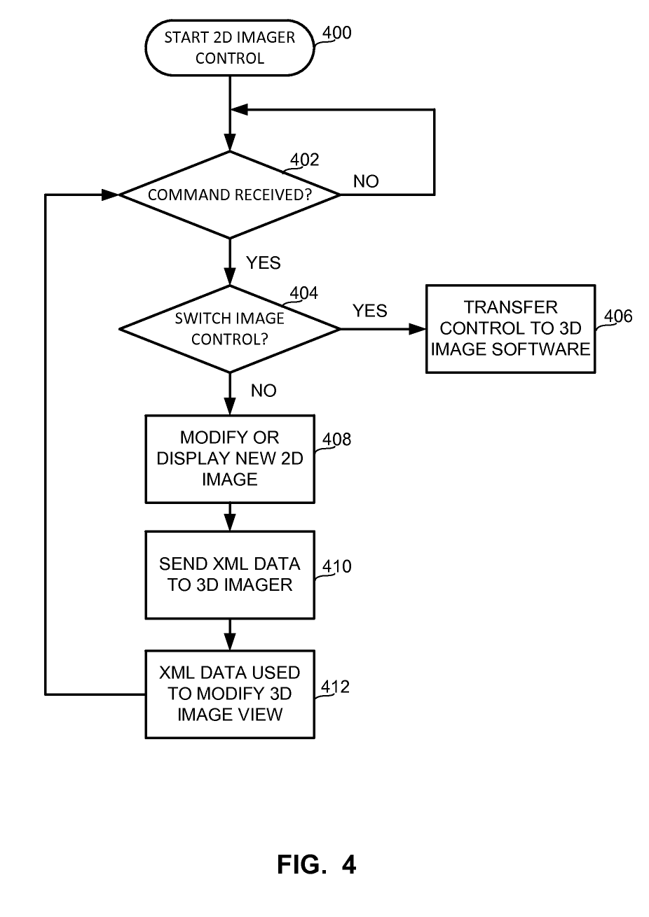

FIG. 4 is a flowchart of example machine readable instructions to implement the 2D imager 106 of FIG. 1. The flowchart begins when control of the imaging system 100 is assigned to the 2D imager 106 (block 400). The 2D imager 106 then waits for a command to be received from the input terminal 112 (block 402). There are a variety of commands that can be received by the input terminal 112 as described above in connection with FIG. 1. Some commands sent by the input terminal 112 cause the displayed 2D image, such as image 606 of FIG. 6 to be modified. Some commands sent by the input terminal 112 cause a new 2D image to be sent to the monitor 114. Other commands sent by the input terminal 112 indicate that the user wishes to modify the 3D image, such as image 608 of FIG. 6, and that therefore control of the imaging system 100 should pass to the 3D imager 108. As such, when a command is received from the input terminal 112, the 2D imager 106 first determines whether control should be passed to the 3D imager 108 (block 404). If the command from the input terminal 112 indicates that control should be passed to the 3D imager 108, then control is passed to the 3D imager 108 and the example of FIG. 4 ends (block 406). If control is not to be passed to the 3D imager 108, then the example of FIG. 4 moves to block 408.

In block 408, the 2D imager 106 interprets the command received from the input terminal 112 and takes the appropriate action. For example, the 2D image 606 of FIG. 6 displayed on the monitor 114 could be modified in some way or a new 2D image could be loaded from the images stored on the 2D imager 106, depending on the specific command received from the input terminal 112. After either the 2D image 606 of FIG. 6 is modified or a new 2D image is loaded, the 2D imager 106 sends XML commands to the 3D imager 108 through the XML transmitter 110 instructing the 3D imager 108 to make the same modification to the displayed 3D image, such as image 608 of FIG. 6, to stay in synch with the displayed 2D image (block 410). The 3D imager 108 then receives the XML commands and makes the appropriate modifications to the 3D image 202 (block 412). The example of FIG. 4 then moves back to block 402, and the 2D imager 106 awaits the next command from the input terminal 112.

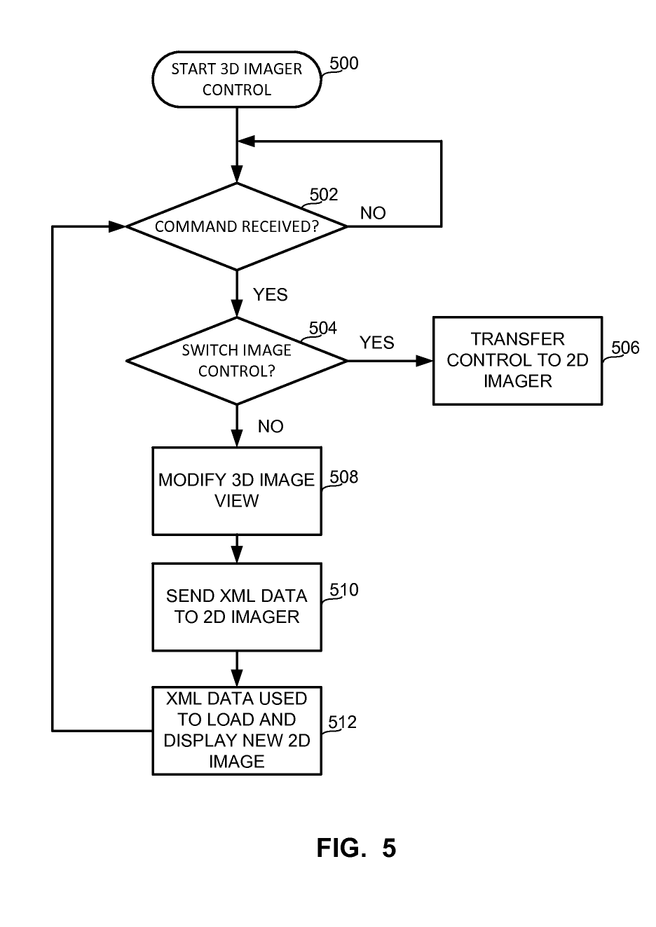

FIG. 5 is a flowchart of example machine readable instructions to implement the 3D imager 108 of FIG. 1. The flowchart begins when control of the imaging system 100 is assigned to the 3D imager 108 (block 500). The 3D imager 108 then waits for a command to be received from the input terminal 112 (block 502). Some such commands from the input terminal 112 cause the 3D image 202 to be modified. Other such commands from the input terminal 112 cause control of the imaging system to be passed to the 2D imager 106. When a command is received from the input terminal 112, the 3D imager 108 first determines whether control should be passed to the 2D imager 106 (block 504). If the command from the input terminal 112 indicates that control should be passed to the 2D imager 106, then control is passed to the 2D imager 106, and the example of FIG. 5 ends (block 506). If control is not to be passed to the 2D imager 106, then the example of FIG. 4 moves to block 508.

In block 508, the 3D imager 108 interprets the command received from the input terminal 112 and takes the appropriate action to modify the displayed 3D image, such as image 608 of FIG. 6, and send the modified image to the monitor 114. After the 3D imager 108 modifies the 3D image, the 3D imager 108 sends XML commands to the 2D imager 106 through the XML transmitter 110 instructing the 2D imager 106 to make the same modification to the 2D image 606 of FIG. 6 to stay in synch with the 3D image 608 (block 510). The 2D imager 106 then receives the XML commands and makes the appropriate modifications to the 2D image 606 of FIG. 6 (block 512). For example, modifications involve modifying the currently displayed 2D image 606 or loading a new 2D image from the 2D images stored in the 2D imager 106. The example of FIG. 5 then moves back to block 502 and the 3D imager 108 awaits the next command from the input terminal 112.

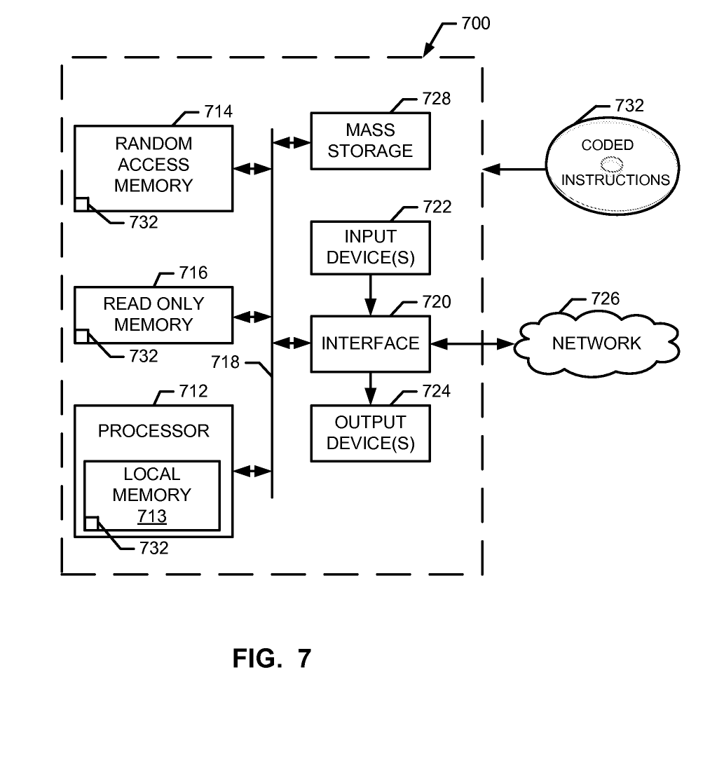

FIG. 7 is a block diagram of a processor platform 700 capable of executing the instructions of FIGS. 3-5 to implement the example medical imaging system 100 of FIG. 1. The processor platform 700 can be, for example, a server, a personal computer, an Internet appliance, a DVD player, a CD player, a Blu-ray player, a gaming console, a personal video recorder, a mobile device (e.g., a smart phone, a tablet, etc.), a printer, or any other type of computing device.

The processor platform 700 of the instant example includes a processor 712. As used herein, the term “processor” refers to a logic circuit capable of executing machine readable instructions. For example, the processor 712 can be implemented by one or more microprocessors or controllers from any desired family or manufacturer.

The processor 712 includes a local memory 713 (e.g., a cache) and is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 also includes an interface circuit 720. The interface circuit 720 may be implemented by any type of interface standard, such as an Ethernet interface, a universal serial bus (USB), and/or a PCI express interface.

One or more input devices 722 are connected to the interface circuit 720. The input device(s) 722 permit a user to enter data and commands into the processor 712. The input device(s) can be implemented by, for example, a keyboard, a mouse, a touchscreen, a track-pad, a trackball, isopoint and/or a voice recognition system.

One or more output devices 724 are also connected to the interface circuit 720. The output devices 724 can be implemented, for example, by display devices (e.g., a liquid crystal display, a cathode ray tube display (CRT), a printer and/or speakers). The interface circuit 720, thus, typically includes a graphics driver card.

The interface circuit 720 also includes a communication device such as a modem or network interface card to facilitate exchange of data with external computers via a network 726 (e.g., an Ethernet connection, a digital subscriber line (DSL), a telephone line, coaxial cable, a cellular telephone system, etc.).

The processor platform 700 also includes one or more mass storage devices 728 for storing software and data. Examples of such mass storage devices 728 include floppy disk drives, hard drive disks, compact disk drives and digital versatile disk (DVD) drives.

The coded instructions 732 of FIG. 7 may be stored in the mass storage device 728, in the volatile memory 714, in the non-volatile memory 716, and/or on a removable storage medium such as a CD or DVD.

Although certain example apparatus, methods, and articles of manufacture have been disclosed herein, the scope of coverage of this patent is not limited thereto. On the contrary, this patent covers all apparatus, methods, and articles of manufacture fairly falling within the scope of the claims of this patent.

What is claimed is:

1. A method comprising:
displaying a first two-dimensional image via a first image viewer on a first screen, wherein the first two-dimensional image is from a first set of images;
displaying a three-dimensional image via a second image viewer on the first screen, wherein the three-dimensional image is constructed from the first set of images and wherein the first image viewer and the second image viewer are linked to share commands and messages;
receiving a first instruction to modify a selected one of the first two-dimensional image or the three-dimensional image;
modifying the selected one of the first two-dimensional image or the three-dimensional image based on the first instruction via the first image viewer or the second image viewer corresponding to the selected image; and
correspondingly modifying the other of the first two-dimensional image or the three-dimensional image based on the first instruction via the other of the first image viewer or the second image viewer corresponding to the unselected one of the first two-dimensional image or the three-dimensional image.

2. The method of claim 1, further comprising displaying a pointer on the three-dimensional image, wherein the pointer is displayed at a first point on the three-dimensional image in which the displayed two-dimensional image is a cross-section of the three-dimensional image at the first point.

3. The method of claim 1, further comprising receiving instructions to add a label to the displayed first two-dimensional image;
adding the label to the displayed first two-dimensional image; and
adding the label to the three-dimensional image at a point on the three-dimensional image in which the displayed first two-dimensional image is a cross-section of the three-dimensional image at that point.

4. The method of claim 1, further comprising receiving instructions to add a label to the three-dimensional image;
adding the label to the three-dimensional image; and
adding the label to each two-dimensional image of the first set of images which represent a cross-section of the three-dimensional image that intersects the label.

5. The method of claim 2, further comprising receiving instructions to display a second two-dimensional image, wherein the second two-dimensional image is from the first set of images and is different from the first two-dimensional image;
displaying the second two-dimensional image in place of the first two-dimensional image; and
moving the pointer to a second point on the three-dimensional image in which the second two-dimensional image is a cross-section of the three-dimensional image at the second point.

6. The method of claim 2, further comprising receiving instructions to move the pointer to a second point on the three-dimensional image;
moving the pointer to the second point on the three-dimensional image; and
displaying a second two-dimensional image, wherein the second two-dimensional image is from the first set of images and the second two-dimensional image to be displayed is a cross-section of the three-dimensional image at the second point.

7. At least one tangible machine readable storage medium comprising instructions that, when executed, cause a machine to at least:
display a first two-dimensional image via a first image viewer on a first screen, wherein the first two-dimensional image is from a first set of images;
display a three-dimensional image via a second image viewer on the first screen, wherein the three-dimensional image is constructed from the first set of images and wherein the first image viewer and the second image viewer are linked to share commands and messages;
receive a first instruction to modify a selected one of the first two-dimensional image or the three-dimensional image;
modify the selected one of the first two-dimensional image or the three-dimensional image based on the first instruction via the first image viewer or the second image viewer corresponding to the selected image; and
correspondingly modify the other of the first two-dimensional image or the three-dimensional image based on the first instruction via the other of the first image viewer or the second image viewer corresponding to the unselected one of the two-dimensional image or the three-dimensional image.

8. At least one storage medium as defined in claim 7, wherein the instructions, when executed, cause the machine to receive instructions to display a pointer on the three-dimensional image, wherein the pointer is displayed at a first point on the three-dimensional image in which the displayed first two-dimensional image is a cross-section of the three-dimensional image at the first point.

9. At least one storage medium as defined in claim 7, wherein the instructions, when executed, cause the machine to receive instructions to add a label to the displayed first two-dimensional image;
add the label to the displayed first two-dimensional image; and
add the label to the three-dimensional image at a point on the three-dimensional image in which the displayed first two-dimensional image is a cross-section of the three-dimensional image at that point.

10. At least one storage medium as defined in claim 7, wherein the instructions, when executed, cause the machine to receive instructions to add a label to the three-dimensional image;
add the label to the three-dimensional image; and
add the label to each two-dimensional image of the first set of images which represent a cross-section of the three-dimensional image that intersects the label.

11. At least one storage medium as defined in claim 8, wherein the instructions, when executed, cause the machine to display a second two-dimensional image, wherein the second image is from the first set of images and is different from the first two-dimensional image;
display the second two-dimensional image in place of the first two-dimensional image; and
move the pointer to a second point on the three-dimensional image in which the second two-dimensional image is a cross-section of the three-dimensional image at the second point.

12. At least one storage medium as defined in claim 8, wherein the instructions, when executed, cause the machine to receive instructions to move the pointer to a second point on the three-dimensional image;
move the pointer to the second point on the three-dimensional image; and
display a second two-dimensional image, wherein the second two-dimensional image is from the first set of images and the second two-dimensional image to be displayed is a cross-section of the three-dimensional image at the second point.

13. An apparatus comprising:
a first image viewer to display a first two-dimensional image on a first screen, wherein the first two-dimensional image is from a first set of images;
a second image viewer to display a three-dimensional image on the first screen, wherein the three-dimensional image is constructed from the first set of images and wherein the first image viewer and the second image viewer are linked to share commands and messages;
an input terminal to receive a first instruction to modify a selected one of the first two-dimensional image or the three-dimensional image, wherein upon receiving the first instruction:
one of the first image viewer or the second image viewer corresponding to the selected image modifies the selected one of the two-dimensional image or the three-dimensional image based on the first instruction; and
the first image viewer or the second image viewer corresponding to the unselected one of the first two-dimensional image or the three-dimensional image correspondingly modifies the other of the two-dimensional image or the three-dimensional image based on the first instruction.

14. The apparatus of claim 13, wherein the second image viewer displays a pointer on the three-dimensional image at a first point on the three-dimensional image in which the displayed two-dimensional image is a cross-section of the three-dimensional image at the first point.

15. The apparatus of claim 13, further comprising an input terminal to receive instructions to add a label to the displayed first two-dimensional image, wherein upon receiving the instructions the first image viewer adds the label to the displayed first two-dimensional image; and
the second image viewer adds the label to the three-dimensional image at a point on the three-dimensional image in which the displayed first two-dimensional image is a cross-section of the three-dimensional image at that point.

16. The apparatus as defined in claim 13, further comprising an input terminal to receive instructions to add a label to the three-dimensional image, wherein upon receiving the instructions the first image viewer adds the label to the three-dimensional image; and
the second image viewer adds the label to each two-dimensional image of the first set of images which represent a cross-section of the three-dimensional image that intersects the label.

17. The apparatus as defined in claim 14, further comprising an input terminal to receive instructions to display a second two-dimensional image, wherein the second image is from the first set of images and is different from the first two-dimensional image and upon receiving the instructions the first image viewer displays the second two-dimensional image in place of the first two-dimensional image; and
the second image viewer moves the pointer to a second point on the three-dimensional image in which the second two-dimensional image is a cross-section of the three-dimensional image at the second point.

18. The method of claim 14, further comprising an input terminal to receive instructions to move the pointer to a second point on the three-dimensional image, wherein upon receiving the instructions the second image viewer moves the pointer to the second point on the three-dimensional image; and
the first image viewer displays a second two-dimensional image, wherein the second two-dimensional image is from the first set of images and the second two-dimensional image to be displayed is a cross-section of the three-dimensional image at the second point.
